(19) United States
(12) Patent Application Publication
(10) Pub. No.: US 2012/0251908 A1
(43) Pub. Date: Oct. 4, 2012

(54) VOLTAGE RECOVERY AND CONTAMINANT REMOVAL BY EX-SITU WATER FLUSH

(75) Inventors: Ashish Bhandari, Niagara Falls (CA); Balasubramanian Lakshmanan, Pittsford, NY (US)

(73) Assignee: GM GLOBAL TECHNOLOGY OPERATIONS LLC, Detroit, MI (US)

(21) Appl. No.: 13/075,954

(22) Filed: Mar. 30, 2011

(51) Int. Cl. H01M 8/04

(52) U.S. Cl. 429/428

(57) ABSTRACT

A system and method for removing contaminants from a fuel cell stack. The method includes exposing the cathode and anode of the stack to an air purge, then exposing the cathode and anode of the stack to a water flush and then again exposing the cathode and anode of the stack to an air purge to dry the stack. In one technique, the stack is removed from the vehicle at a maintenance facility to perform the air purge and water flush, and in another technique, the stack remains in the vehicle and appropriate hoses are connected to the stack for the air purges and water flush.

### BACKGROUND OF THE INVENTION

1. Field of the Invention

This invention relates generally to a system and method for removing contaminants from a fuel cell stack and, more particularly, to a system and method for removing contaminants from a fuel cell stack that includes purging the cathode and anode of the fuel cell stack with air, flushing the anode and cathode of the stack with water and then drying the cathode and anode of the stack with air.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte there between. The anode receives hydrogen gas and the cathode receives oxygen or air. The hydrogen gas is dissociated at the anode catalyst to generate free protons and electrons. The protons pass through the electrolyte to the cathode. The protons react with the oxygen and the electrons at the cathode catalyst to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically, but not always, include finely divided catalytic particles, usually a highly active catalyst such as platinum (Pt) that is typically supported on carbon particles and mixed with an ionomer. The catalytic mixture is deposited on opposing sides of the membrane. The combination of the anode catalytic mixture layer, the cathode catalytic mixture layer and the membrane define a membrane electrode assembly (MEA). MEAs are relatively expensive to manufacture and require certain conditions for effective operation.

Several fuel cells are typically combined in a fuel cell stack to generate the desired power. For example, a typical fuel cell stack for a vehicle may have two hundred or more stacked fuel cells. The fuel cell stack receives a cathode reactant input gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant input gas that flows into the anode side of the stack.

A fuel cell stack typically includes a series of bipolar plates positioned between the several MEAs in the stack, where the bipolar plates and the MEAs are positioned between two end plates. The bipolar plates include an anode side and a cathode side for adjacent fuel cells in the stack. Anode gas flow fields are provided on the anode side of the bipolar plates that allow the anode reactant gas to flow to the respective MEA. Cathode gas flow fields are provided on the cathode side of the bipolar plates that allow the cathode reactant gas to flow to the respective MEA. One end plate includes anode gas flow channels, and the other end plate includes cathode gas flow channels. The bipolar plates and end plates are made of a conductive material, such as stainless steel or a conductive composite. The end plates conduct the electricity generated by the fuel cells out of the stack. The bipolar plates also include flow channels through which a cooling fluid flows.

The membrane within a fuel cell need to have sufficient water content so that the ionic resistance across the membrane is low enough to effectively conduct protons. Membrane humidification may come from the stack water by-product or external humidification. The flow of reactants through the flow channels of the stack has a drying effect on the cell membranes, most noticeably at an inlet of the reactant flow. However, the accumulation of water droplets within the flow channels could prevent reactants from flowing therethrough, and may cause the cell to fail because of low reactant gas flow, thus affecting stack stability. The accumulation of water in the reactant gas flow channels, as well as within the gas diffusion layer (GDL), is particularly troublesome at low stack output loads.

As mentioned above, water is generated as a by-product of the stack operation. Therefore, the cathode exhaust gas from the stack will typically include water vapor and liquid water. It is known in the art to use a water vapor transfer (WVT) unit to capture some of the water in the cathode exhaust gas, and use the water to humidify the cathode input airflow. Water in the cathode exhaust gas at one side of the water transfer elements, such as membranes, is absorbed by the water transfer elements and is transferred to the cathode air stream at the other side of the water transfer elements.

In a fuel cell system, there are a number of mechanisms that cause permanent loss of stack performance, such as loss of catalyst activity, catalyst support corrosion and pinhole formation in the cell membranes. However, there are other mechanisms that can cause stack voltage losses, and thus loss of stack performance, that are substantially reversible, such as the cell membranes drying out, catalyst oxide formation, and build-up of contaminants, such as anions, sulfates and glycol, on both the anode and cathode side of the stack. Therefore, there is a need in the art to remove the oxide formations and the build-up of contaminants, as well as to rehydrate the cell membranes, to recover losses of cell voltage in a fuel cell stack.

Wet stack operation, that is, operation with a high amount of humidification, is desirable for system humidification, performance and contaminant removal. However, there are various reasons to operate a fuel cell stack with a lower amount of humidification. For example, wet stack operation can lead to fuel cell stability problems due to water build up, and could also cause anode starvation resulting in carbon corrosion. In addition, wet stack operation can be problematic in freeze conditions due to liquid water freezing at various locations in the fuel cell stack. Therefore, there is a need in the art for systems that are optimized for drier operating conditions.

Contaminants can be deposited and absorbed on the MEA electrodes in the cells and in the stack from various sources. These sources include various contaminants that may reside in the hydrogen gas and air that enter the flow channels of the stack, off gassing from various plastic components within the fuel cell system and degradation of products from the membrane itself. These contaminants build up over time causing loss of catalyst performance, which effects stack operation. However, much of these contaminants can be removed, where loss of cell voltage can be recovered.

U.S. patent application Ser. No. 12/580,912, filed Oct. 16, 2009, titled Automated Procedure For Executing In-Situ Fuel Cell Stack Reconditioning, assigned to the assignee of this application and herein incorporated by reference, discloses a system and method for reconditioning a fuel cell stack that includes increasing the humidification level of the cathode side of the stack to hydrate the cell membranes and providing hydrogen to the anode side of the fuel cell stack at system shut-down, where the system monitors reconditioning event triggers, reconditioning thresholds and reconditioning system checks so that the reconditioning process can be provided during vehicle operation.

Generally, stack reconditioning includes running the fuel cell stack with high relative humidity to remove contaminates from the stack to recover from stack degradation. However, reconditioning is an abnormal operation and exposes the stack to wet operations that may cause reliability issues if liquid water ends up in anode flow-fields and low anode flow rates are not able to purge them out. Thus, reconditioning should be performed only when it is absolutely necessary. Previous stack reconditioning triggers included triggering the reconditioning by monitoring the number of vehicle trips or key cycles. If the number of trips exceeded a threshold, which is considered as a representation of time after which stack voltage has degraded, the reconditioning process is triggered. However, improvements in triggering the reconditioning process can be made so that the reconditioning is only performed when necessary to reduce the abnormal operation conditions.

### SUMMARY OF THE INVENTION

In accordance with the teachings of the present invention, a system and method are disclosed for removing contaminants from a fuel cell stack. The method includes exposing the cathode and anode of the stack to an air purge, then exposing the cathode and anode of the stack to a water flush and then again exposing the cathode and anode of the stack to an air purge to dry the stack. In one technique, the stack is removed from the vehicle at a maintenance facility to perform the air purge and water flush, and in another technique, the stack remains in the vehicle and appropriate hoses are connected to the stack for the air purges and water flush.

### BRIEF DESCRIPTION OF THE DRAWINGS

FIG. 1 is a block diagram of a fuel cell system;

FIG. 2 is a flow chart diagram showing a method for removing contaminants from a fuel cell stack where the stack is removed from the vehicle; and

FIG. 3 is a method for removing contaminants from a fuel cell stack where the stack remains in the vehicle.

### DETAILED DESCRIPTION OF THE EMBODIMENTS

The following discussion of the embodiments of the invention directed to a system and method for removing contaminants from a fuel cell stack is merely exemplary in nature, and is in no way intended to limit the invention or its applications or uses.

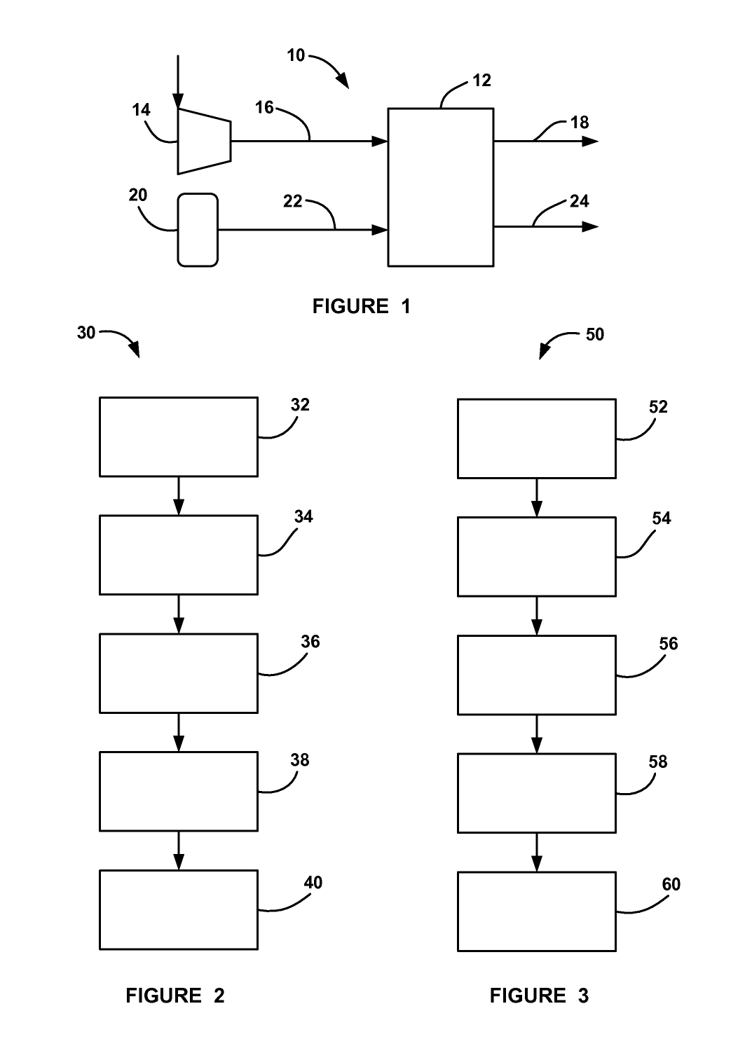

FIG. 1 is a simplified block diagram of a fuel cell system 10 including a fuel cell stack 12 for a vehicle. A compressor 14 provides an airflow to the cathode side of the fuel cell stack 12 on a cathode input line 16 and a cathode exhaust gas is output from the stack 12 on a cathode exhaust gas line 18. The anode side of the fuel cell stack 12 receives a hydrogen gas from a hydrogen source 20 on an anode input line 22 and an anode exhaust gas is output from the stack 12 on an anode exhaust gas line 24. The fuel cell system 10 is intended to represent any fuel cell system suitable for the contaminant removal process described herein, including anode recirculation systems, anode flow-shifting systems, etc. However, the fuel cell system 10 is a fuel cell system applicable to provide power for vehicle propulsion.

FIG. 2 is a flow chart diagram 30 showing a process for removing contaminants, such as anions, sulfates and glycol, from the fuel cell stack 12. At box 32, the stack 12 is removed from the vehicle at a suitable service or maintenance facility where an appropriate air purge and water flush can be performed on the stack 12, as discussed below. At box 34, an air purge is performed for both the cathode side and the anode side of the stack 12. Particularly, suitable hoses, valves and other plumbing are connected to the various cathode and anode manifolds of the fuel cell stack 12 so that air can flow through the flow channels within each of the fuel cells in the stack 12 to force air through the diffusion media and contact the MEAs in each of the fuel cells in stack 12. The air flow reacts with various contaminants on the various surfaces in the flow channels, on the catalyst, on the carbon support surfaces, etc. to either forcibly remove the contaminants by the air pressure or cause a chemical reaction that changes the state of the contaminants. The air purge can be performed at any suitable air pressure, at any suitable air temperature for the particular contaminants being removed and for any suitable period of time.

Next, suitable plumbing is connected to the manifolds of the fuel cell stack 12 to perform a water flush of the cathode and anode at box 36 to remove additional contaminants from the MEAs and other surfaces within the stack 12. The water flush can be performed at any suitable flow rate or flow pressure and at any suitable water temperature for any desirable application, and for any desirable period of time. The water flows into the fuel cells in the stack 12 from the flow channels to saturate the diffusion media and wash away the various contaminates that have absorbed onto the catalyst and its support structure on the MEAs. The contaminants are dissolved or suspended in the water and are carried away with the water flow through the fuel cells in the stack 12. In one non-limiting embodiment, the water flush is performed with deionized water. Once the water flush has removed the contaminants to the desirable level, then another air purge for the anode and cathode of the stack 12 is performed at box 38 to dry the membranes and other layers in the stack 12. The stack 12 is then reinstalled in the vehicle at box 40.

By removing these contaminants in this manner from the active area of the MEA, thus making the platinum sites more available, average cell voltage has been shown to be recovered to about 30 mV. This process for cell voltage recovery has been shown to be equivalent to the recovery obtained by running the stack 12 for multiple hours under wet operating conditions.

The discussion above for the flow diagram 30 includes removing the stack 12 from the vehicle. However, in other embodiments, it may be possible to keep the stack 12 in the vehicle and still perform the air purge and the water flush. This embodiment is shown by a flow diagram 50 in FIG. 3 where the stack 12 remains in the vehicle and the necessary hoses and pipes are connected to the stack manifolds at box 52. This embodiment may require that various plumbing including hydrogen lines, cooling fluid lines, air lines, etc. be disconnected from the stack 12 before the air purge and water flush lines are connected to the fuel cell stack 12. As above, the cathode and anode air purge is performed at box 54, the anode and cathode water flush is performed at box 56, the anode and cathode dry air purge is performed at box 58. The hoses and pipes are then disconnected from the stack 12 at box 60.

The above procedure enhances the ability of the fuel cell MEAs to react the fuel and oxidant because (1) the higher fraction of liquid water enables any soluble contaminates to wash off, (2) the higher level of membrane electrode saturation increases the proton conductivity of the membrane and electrode, (3) the reduction in voltage under wet conditions leads to the reduction in the surface coverage of sulfate (HSO₄⁻)-like poisoning species which then get washed off during subsequent operation, and (4) the reduction of surface oxides, such as platinum oxide (PtO) and platinum hydroxide (PtOH), which expose more of the precious metal sites.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for removing contaminants from a fuel cell stack, said method comprising:
purging a cathode side and an anode side of the fuel cell stack with air;
flushing the cathode side and the anode side of the fuel cell stack with water after the cathode and the anode side of the fuel cell stack have been purged with air; and
purging the cathode side and the anode side of the fuel cell stack with air to dry the stack after the cathode side and the anode side of the fuel cell stack have been flushed with water.

2. The method according to claim 1 further comprising removing the fuel cell stack from a vehicle before the fuel cell stack is purged with air.

3. The method according to claim 2 further comprising reinstalling the fuel cell stack back in the vehicle after the cathode side and the anode side of the stack are purged with air to dry the stack.

4. The method according to claim 1 wherein purging the cathode side and the anode side of the stack with air and flushing the cathode and anode side of the stack with water includes purging the stack and flushing the while the stack is within a vehicle.

5. The method according to claim 1 wherein the contaminants that are removed from the stack include anions, sulfates and glycol.

6. The method according to claim 1 wherein flushing the cathode side and the anode side of the fuel cell stack with water includes using deionized water.

7. A method for removing contaminants from a fuel cell stack in a vehicle, said method comprising:
removing the fuel cell stack from the vehicle;
purging a cathode side and an anode side of the fuel cell stack with air;
flushing the cathode side and the anode side of the fuel cell stack with water after the cathode side and the anode side of the fuel cell stack have been purged with air;
purging the cathode side and the anode side of the fuel cell stack with air to dry the stack after the cathode side and the anode side of the fuel cell stack have been flushed with water; and
reinstalling the fuel cell stack into the vehicle.

8. The method according to claim 7 wherein the contaminants that are removed from the stack include anions, sulfates and glycol.

9. The method according to claim 7 wherein flushing the cathode side and the anode side of the fuel cell stack with water includes using deionized water.

10. A method for removing contaminants from a fuel cell stack in a vehicle, said method comprising:
purging a cathode side and an anode side of the fuel cell stack with air while the fuel cell stack is in the vehicle;
flushing the cathode side and the anode side of the fuel cell stack with water after the cathode side and the anode side of the fuel cell stack have been purged with air while the fuel cell stack is in the vehicle; and
purging the cathode side and the anode side of the fuel cell stack with air to dry the stack after the cathode side and the anode side of the fuel cell stack have been flushed with water while the stack is within the vehicle.

11. The method according to claim 10 wherein the contaminants that are removed from the stack include anions, sulfates and glycol.

12. The method according to claim 10 wherein flushing the cathode side and the anode side of the fuel cell stack with water includes using deionized water.
